(19) United States
(12) Patent Application Publication
(10) Pub. No.: US 2009/0005163 A1
(43) Pub. Date: Jan. 1, 2009

(54) Private game terminal

(76) Inventor: Miguel Angel Quetglas Arino, Barcelona (ES)

Correspondence Address: Ralph A. Dowell of DOWELL & DOWELL P.C., 2111 Eisenhower Ave, Suite 406, Alexandria, VA, 22314, US

(21) Appl. No.: 12/068,847

(22) Filed: Feb. 12, 2008

(30) Foreign Application Priority Data
Jun. 27, 2007 (ES) 200701882

(51) Int. Cl. A63F 13/00

(52) U.S. Cl. 463/32

(57) ABSTRACT

Terminal comprising a processing unit (11) with a network connection (12) to a server computer (12) and user-interface media connected to the said processing unit (11), enabling individual or shared prize betting games to be played, whose interface media comprises personal-viewing goggles (13), earphones (14) for listening, and tactile media (15) for controlling the terminal, operationally suitable for enabling a user to play the games in full privacy. The personal viewing goggles (13) use stereoscopic vision, with the optional incorporation of earphones (14). The tactile input media (15) comprises a plate that responds to the contact of the user's finger to establish a position and/or the absolute or relative movement of a cursor or pointer in the viewer.

### OBJECT OF THE INVENTION

This invention refers to a private game terminal of the sort used for recreational betting game machines, preferably connected by network to a server and other terminals.

### BACKGROUND OF THE INVENTION

There exist various types of known betting game machines or game terminals that are used individually or connected by a network to a server computer. It is also common in the casinos and bingo halls for these terminals to be arranged in groups or set out in lines so that they can be used by different players, with different play modes available, according to the selected terminal. These terminals comprise a processing unit with a network connection to the aforementioned server computer that can be used to: load the user's selected game; coordinate the potential prizes that are combined with other machines; produce statistics of use, notifications of incidents and other services. The processing unit is housed in a considerably large piece of furniture, which also incorporates user interface media, generally a video screen or luminous interactive buttons and panels, as well as an audio system for reproducing sounds related to events and music entertainment. These terminals are visually very striking and when many are placed together in groups, the visual impact and noise can be considerable, causing some players to feel uncomfortable or unable to concentrate on the game.

Also, in said casinos and bingo halls, in addition to the players on the terminals, it is normal for there to be other people walking around for the pleasure of watching the games being played, which can be annoying for the active players, thus increasing the latter's discomfort and entailing a lack of privacy.

### DESCRIPTION OF THE INVENTION

The private game terminal that is the object of this invention introduces technical particularities aimed at improving the conditions of privacy and comfort of network-based betting game players.

More specifically, the terminal's user interface means comprise personal-viewing goggles, earphones for listening to sounds and music and tactile media for controlling the terminal so that the games can be operated in full privacy.

Thus, using the personal-viewing goggles, only the player can see the screen of a conventional game terminal or any chosen graphics environment. At the same time, using the tactile input media, the player can move a marker symbol or cursor, e.g. in the form of a semi-transparent or solid finger, to interact virtually with the screen or graphic environment they are watching. Also, by using the earphones the player will hear only the sounds the terminal reproduces and the messages that are directed specifically at the player, as well as notification of opportunities for placing special bets or taking their accumulated winnings.

The goggles may have stereoscopic vision, whether using a pair of small TFT (Thin Film Transistor) liquid crystal or OLED (Organic Light-Emitting Diode) screens, or screens that use other technologies, making it possible to recreate a more realistic, three-dimensional games environment. Furthermore, the earphones can be integrated or linked to the personal viewing goggles, so that the user can comfortably put on the interface media at the start of the game.

The tactile input media can be in the form of a touch plate that responds to the contact of the user's finger, establishing a position and/or the absolute or relative movement of a cursor or pointer in the viewer, so that the player can handle the machine more intuitively. This plate may comprise a resistive, capacitive sensor with a surface-acoustic wave (SAW) or similar. These tactile input media can be integrated in the processing unit box or, alternatively, in a seating element that is accessible to the user, such as, for example an arm support, or other easily accessible places.

### DESCRIPTION OF THE FIGURES

To supplement the description set out in this document and for a better understanding of the specifications of the invention, a set of drawings is attached to this descriptive report, including but not limited to the following:

FIG. 1 shows a sketch of the blocks of the invention terminal and its connection to the server computer.

FIG. 2 shows an outline sketch of the various terminals configured on chairs and their connection to the server computer.

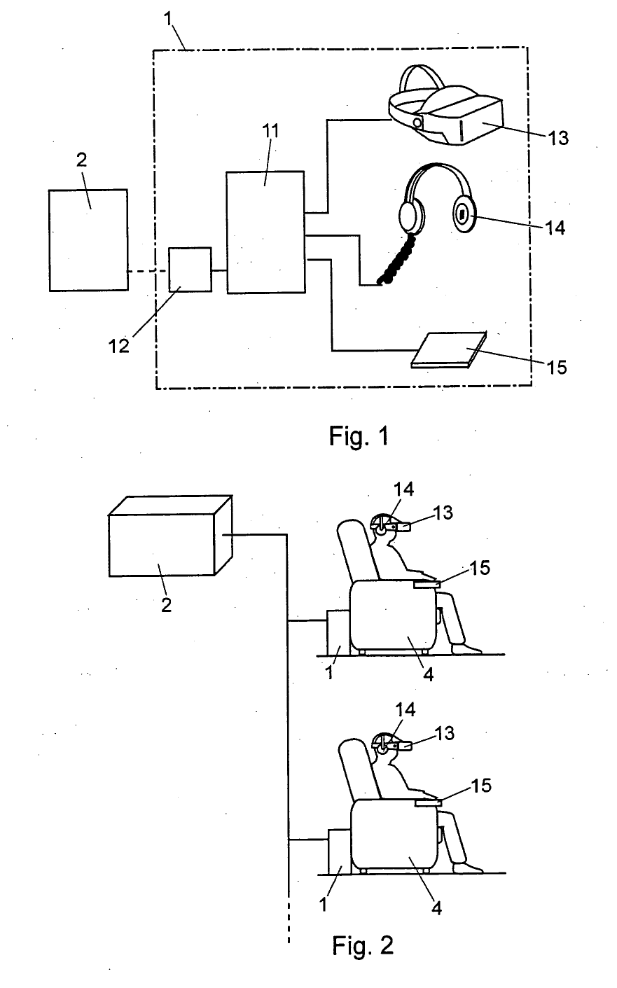

### PREFERRED SET-UP OF THE INVENTION

As shown in the referenced figures, this invention comprises a terminal (1) that can be connected to a server computer (2) to offer betting games or similar, either separately or jointly with other adjacent terminals (1).

Each terminal (1) comprises a processing unit (11) with a network connection (12) and the said processing unit (11) is connected to personal viewing goggles (13) and sound reproduction earphones (14) so that users can observe and listen to the game they wish to play. In addition, the terminal (1) comprises tactile media (15) for controlling the terminal and the game, composed of a touch plate that responds to contact, fitted in the arm support of a chair (4) where players can sit when using the terminal (1), as shown in FIG. 2.

Having described the nature of the invention sufficiently and having provided an example of the preferred setup, in order to complete the formalities deemed necessary, we hereby state, that the materials, form, size and layout of the described elements may be modified, insofar as this does not involve altering the essential specifications of the invention as claimed below.

1. Private game terminal of the type made up of a processing unit (11) with a network connection (12) to a server computer (12) and user-interface media that are connected to said processing unit (11), enabling individual or shared prize betting games to be played, characterised because the interface media comprise personal-viewing goggles (13), earphones (14) for listening to sounds and media and tactile media (15) for controlling the terminal, operationally suitable for enabling a user to play the games in full privacy.

2. Terminal, according to claim 1, characterised by the stereoscopic vision of the personal viewing goggles (13).

3. Terminal, according to claim 1, characterised because the earphones (14) are integrated or linked to the personal viewing goggles (13).

4. Terminal, according to claim 1, characterised by the tactile input media (15), a plate that responds to the contact of the user's finger, to establish a position and/or the absolute or relative movement of a cursor or pointer in the viewer.

5. Terminal, according to claim 1, characterised because the tactile input media (15) are integrated into the processing unit box (11).

6. Terminal, according to claim 1, characterised because the tactile input media (15) are incorporated into a seating element, accessible to the user.
